(19) United States
(12) Patent Application Publication
(10) Pub. No.: US 2023/0339184 A1
(43) Pub. Date: Oct. 26, 2023

(54) CENTRIFUGAL CLEANING APPARATUS WITH PLATFORM-REVERSIBLE ROTOR FOR ADDITIVELY MANUFACTURED OBJECTS

(71) Applicant: Carbon, Inc., Redwood City, CA (US)

(72) Inventors: Clara Lynne Takahashi, San Francisco, CA (US); Alexander D. Denmark, Redwood City, CA (US)

(21) Appl. No.: 18/303,788

(22) Filed: Apr. 20, 2023

Related U.S. Application Data
(60) Provisional application No. 63/333,741, filed on Apr. 22, 2022.

(51) Int. Cl. B29C 64/35; B33Y 40/20; B33Y 10/00

(52) U.S. Cl. CPC B29C 64/35; B33Y 40/20; B33Y 10/00

(57) ABSTRACT

A centrifugal separator for separating residual resin from additively manufactured objects, the objects carried on a build surface of a build platform on which the objects were additively manufactured. The separator includes: an outer vessel; a rotor in the vessel, the rotor defining a center axis of rotation; a drive assembly operatively associated with the rotor; and a plurality of build platform mount assemblies operatively associated with the rotor, each mount assembly configured to receive one of the build platforms in (i) a first orientation in which the build surfaces face toward the axis of rotation, and (ii) a second orientation in which the build surfaces face away from the axis of rotation.

### RELATED APPLICATIONS

This application claims priority from U.S. Provisional Application Ser. No. 63/333,741, filed Apr. 22, 2022, the disclosure of which is hereby incorporated by reference in its entirety.

### FIELD

Centrifugal separators, additive manufacturing build platforms, and methods of using the same for cleaning additively manufactured objects are described herein.

### BACKGROUND

Polymer dental appliances such as clear aligners are made by additively manufacturing a mold in the shape of a patient's dental arch, and then thermoforming a sheet of thermoplastic material over that mold. See, e.g., U.S. Pat. No. 7,261,533. Prior to thermoforming, it is important that residual resin be cleaned from all surfaces of the molds—typically accomplished by washing the molds with ethanol (See, e.g., Van Esbroek, Sharma, Lam and Chin, Method and apparatus for forming an orthodontic aligner, U.S. Pat. No. 10,575,925; see also Graham, Laaker and Barth, Rapid Wash System for Additive Manufacturing, US Patent App. Pub. No. US 2019/0255774).

A problem with washing, however, is that it produces contaminated wash liquids which present further processing problems. A possible alternative is centrifugal cleaning, which has been generally described for additive manufactured objects (Murillo and Dachs, Resin extractor for additive manufacturing, US Patent App. Pub. No. 2021/0086450 (Mar. 25, 2021); Hiatt et al., Method for removing and reclaiming unconsolidated material from substrates following fabrication of objects thereon by programmed material consolidation techniques, US Patent App. Pub. No. 2004/0159340 (Aug. 19, 2004); and Converse et al., Systems and methods for resin recovery in additive manufacturing, PCT Patent App. Pub. No. WO 2020/146000 (Jul. 16, 2020)).

Another problem with additively manufactured thermoforming molds is that the molds themselves are typically discarded. This represents considerable waste of material, and hence it is also desirable to minimize the amount of material from which the mold is made. This might be achievable by making hollow molds. However, centrifugal cleaning hollow molds appears difficult, as the hollow cavities themselves, in addition to the outer surfaces of the mold, must also be cleaned—and centrifugation procedures that are optimized for cleaning the surface of a mold may not be effective in cleaning an interior cavity within the mold. Accordingly, there is a need for new approaches to cleaning hollow molds for use in making dental appliances.

### SUMMARY

Some embodiments of the present invention are directed to a centrifugal separator for separating residual resin from additively manufactured objects, the objects carried on a build surface of a build platform on which the objects were additively manufactured. The separator includes: an outer vessel; a rotor in the vessel, the rotor defining a center axis of rotation; a drive assembly operatively associated with the rotor; and a plurality of build platform mount assemblies operatively associated with the rotor, each mount assembly configured to receive one of the build platforms in (i) a first orientation in which the build surfaces face toward the axis of rotation, and (ii) a second orientation in which the build surfaces face away from the axis of rotation.

In some embodiments, each mount assembly is configured to slidably receive the build platform in both the first orientation and the second orientation.

In some embodiments, the separator further includes a shield connected to the rotor beneath said build platform mount assemblies, the shield configured to reduce contact of residual resin to the back surface of the build platforms when the build platforms are received in said mount assemblies in said first orientation in which the build surfaces face toward said axis of rotation.

In some embodiments, the mount assemblies are configured to receive each build platform with a top portion thereof leaning towards said axis of rotation (e.g., by an angle of 3, 4 or 5 degrees, up to 10 or 12 degrees from vertical).

In some embodiments, the mount assemblies include at least one resin flow feature configured for channeling, collecting, and/or directing the flow of residual resin during centrifugal separation of residual resin from additively manufactured objects on the build surface.

In some embodiments, the mount assemblies include at least one pair of opposite facing bumpers or rails configured for abutting side edge portions of a build platform, or configured for engaging corresponding engagement features on a build platform side edge portion.

Some other embodiments of the present invention are directed to a method of separating residual resin from additively manufactured objects, the objects carried on a build surface of a build platform on which the objects were additively manufactured. The method includes: mounting a plurality of build platforms to a rotor of a centrifugal separator in either (i) an orientation in which all of the build surfaces face toward an axis of rotation of the rotor, or (ii) an orientation in which all of the build surfaces face away from the axis of rotation; then centrifugally separating residual resin from said additively manufactured objects by spinning said rotor; then removing each of the plurality of build platforms from the rotor; and re-mounting each of the plurality of build platforms to said rotor in the other of (1) the orientation in which all of the build surfaces face towards the axis of rotation, or (ii) the orientation in which all of the build surfaces face away from said axis of rotation; and then centrifugally separating additional residual resin from the additively manufactured objects by spinning the rotor.

In some embodiments, the objects include an external surface and an internal cavity, chamber, or well having an internal surface, wherein said residual resin is on both the external surface and the internal surface, and the objects include at least one passage between the external surface and the internal surface.

In some embodiments, the mounting step is carried out with the build platforms facing toward the axis of rotation, and the re-mounting step is carried out with the build platforms facing away from the axis of rotation.

In some embodiments, all of the build platforms have the same configuration, each has a center of mass, and both the mounting and re-mounting steps are carried out with the center of mass located the same distance (plus or minus 5 or 10 percent) from the axis of rotation.

In some embodiments, each object includes a mold in the shape of a dental arch produced by additive manufacturing from a polymerizable resin, the mold including: an outer surface portion including an upper portion configured in the shape of a set of teeth and an intermediate portion; a planar base surface portion; a hollow cavity formed in the intermediate portion, the hollow cavity extending through the base surface portion and optionally (but in some embodiments preferably) extending into the upper portion; and a plurality of drain channels extending from the hollow cavity through said outer surface portion, the drain channels configured for draining residual polymerizable resin from the hollow cavity during the centrifugally separating step.

In some embodiments, each mold is oriented horizontally on the build surfaces, with the mold bottom surface portions adhered to the build surfaces.

In some embodiments, the centrifugally separating steps are carried out in a vessel, and either one, or both, of the centrifugally separating steps further include channeling or directing separated residual resin toward a limited location within said vessel (for example, where the vessel has an interior wall with an upper and lower portion, channeling or directing separated residual resin towards the lower portion).

In some embodiments, the channeling or directing are carried out with at least one, or a plurality of, resin flow features operatively associated with each mount assembly, each build platform, or a combination thereof (i.e., cooperating flow-directing features formed on, connected to, or operatively associated with both the mount assemblies and the build platforms).

Some other embodiments of the present invention are directed to a build platform on which objects can be produced by additive manufacturing and then cleaned of residual resin in a centrifugal separator, the centrifugal separator having an axis of rotation, the build platform including: (a) a body having a (preferably generally rectangular) planar build surface, a top portion, a bottom portion, and two opposing side portions; (b) a first pair of opposite-facing engagement features on the opposing side portions, the engagement features configured for engaging a build platform mount of a centrifugal separator in a first orientation in which the build surface faces toward the axis of rotation; and (c) a second pair of opposite-facing engagement features on the opposing side portions, the engagement features configured for engaging a build platform mount of a centrifugal separator in a second orientation in which the build surface faces away from the axis of rotation.

In some embodiments: the first pair of opposite-facing engagement features include a slot or rail extending along each opposing side portion; and/or the second pair of opposite-facing engagement features include a slot or rail extending along each said opposing side portion.

In some embodiments, the build platform further includes a resin flow feature (e.g., a gutter, drain, awning, channel, or the like) on the opposing side portions, and optionally but preferably on the bottom portion, the flow feature configured for channeling, collecting, and/or directing the flow of residual resin during centrifugal separation of residual resin from additively manufactured objects on the build surface.

The foregoing and other objects and aspects of the present invention are explained in greater detail in the drawings herein and the specification set forth below. The disclosures of all United States patent references cited herein are to be incorporated herein by reference.

### BRIEF DESCRIPTION OF THE DRAWINGS

FIG. 1A is a perspective view of a hollow dental model to be used as a thermoforming mold for making a dental appliance.

FIG. 1B is a bottom view of the hollow dental model of FIG. 1A.

FIG. 2 is a perspective view of an additive manufacturing build platform on which a plurality of hollow dental models of FIGS. 1A-1B (all varying slightly from one another depending on patient and/or treatment stage) are additively manufactured.

FIG. 3A is a top plan schematic view of a centrifugal separator as described herein, with the build platforms facing away from the axis of rotation.

FIG. 3B is a top plan schematic view of the centrifugal separator of FIG. 3A with the build platforms facing towards the axis of rotation.

FIG. 4A is a top view of a particular embodiment of a centrifugal separator rotor as described herein. The triangle adjacent the handle indicates the side of the build platform on which parts are printed (that is, the “build surface”). Note that, for purposes of illustration, two platforms are positioned with their build surfaces facing in, while one is positioned with its build surface facing out. In use, all would be positioned with their build surfaces facing in the same direction.

FIG. 4B is a perspective view of the rotor of FIG. 4A.

FIG. 5A is a detailed view of the centrifugal separator of FIG. 4A, showing a build platform in place and facing toward the axis of rotation, with slidable insertion of the build platform into (and engagement to) the rotor indicated by circle B.

FIG. 5B is a detailed view of the centrifugal separator of FIG. 4A, showing a build platform in place and facing away from the axis of rotation, with slidable insertion of the build platform into (and engagement to) the rotor indicated by circle D.

FIG. 6A is a side sectional, detailed view of a rotor and build plate with the build plate resting on a bottom bumper and facing toward the axis of rotation. A drainage awning on the platform is shown nested into a channel in the bottom bumper in circle F, the two together directing residual resin from the platform into the channel in the bottom bumper.

FIG. 6B is a top plan view of the bottom bumper shown in cross section in FIG. 6A.

FIG. 6C is a side sectional view of the bottom bumper of FIGS. 6A-6B, taken along line G-G of FIG. 6B. Together they show that the channel is angled to help direct residual resin out of the channel and into the lower section of the separator vessel.

FIG. 7A is a lower, long side, view of the build platform shown in part in FIGS. 4A-6A above. This is the side that rests against the bottom bumper in FIGS. 6A-6C.

FIG. 7B is a top plan view of the build platform of FIG. 7A.

FIG. 7C is a short side view of the build platform shown in FIGS. 7A-7B.

### DETAILED DESCRIPTION OF ILLUSTRATIVE EMBODIMENTS

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

As used herein, the term “and/or” includes any and all possible combinations of one or more of the associated listed items, as well as the lack of combinations when interpreted in the alternative (“or”).

### 1. Additive Manufacturing.

Suitable additive manufacturing methods and apparatus, including bottom-up and top-down additive versions thereof (generally known as stereolithography or “SLA”) are known and described in, for example, U.S. Pat. No. 5,236,637 to Hull, U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, U.S. Patent Application Publication No. 2013/0292862 to Joyce, US Patent Application Publication No. 2013/0295212 to Chen et al., and U.S. Pat. No. 5,247,180 to Mitcham and Nelson (Texas Instruments patent describing SLA with micromirror array). The disclosures of these patents and applications are incorporated by reference herein in their entirety.

In some embodiments, the additive manufacturing step is carried out by one of the family of methods sometimes referred to as continuous liquid interface production (CLIP). CLIP is known and described in, for example, U.S. Pat. Nos. 9,211,678; 9,205,601; 9,216,546; and others; in J. Tumbleston et al., Continuous liquid interface production of 3D Objects, Science 347, 1349-1352 (2015); and in R. Janusziewcz et al., Layerless fabrication with continuous liquid interface production, Proc. Natl. Acad. Sci. USA 113, 11703-11708 (Oct. 18, 2016). Other examples of methods and apparatus for carrying out particular embodiments of CLIP include, but are not limited to: Batchelder et al., US Patent Application Pub. No. US 2017/0129169 (May 11, 2017); Sun and Lichkus, US Patent Application Pub. No. US 2016/0288376 (Oct. 6, 2016); Willis et al., US Patent Application Pub. No. US 2015/0360419 (Dec. 17, 2015); Lin et al., US Patent Application Pub. No. US 2015/0331402 (Nov. 19, 2015); D. Castanon, S Patent Application Pub. No. US 2017/0129167 (May 11, 2017). B. Feller, US Pat App. Pub. No. US 2018/0243976 (published Aug. 30, 2018); M. Panzer and J. Tumbleston, US Pat App Pub. No. US 2018/0126630 (published May 10, 2018); K. Willis and B. Adzima, US Pat App Pub. No. US 2018/0290374 (Oct. 11, 2018) L. Robeson et al., PCI Patent Pub. No. WO 2015/164234 (see also U.S. Pat. Nos. 10,259,171 and 10,434,706); and C. Mirkin et al., PCT Patent Pub. No. WO 2017/210298 (see also US Pat. App. US 2019/0160733),

### 2. Additively Manufactured Objects.

The methods described herein can be carried out on any object, produced by an additive manufacturing process such as described above, for which centrifugal separation of residual resin in two orientations is advantageous. This may be due to wells, pockets, recesses or the like in the object that may inhibit the flow of residual resin if spun in only one orientation, reduction of speed of spinning (and forces on the object) attainable by spinning in two orientations, or combinations thereof.

Typically, and as shown in FIG. 2, the objects are manufactured on the build surface 52 of a build platform 51. Any suitable build platform can be used, including but not limited to that described in Dachs, Removable build platform for an additive manufacturing apparatus, PCT Patent Application Pub. No. WO2020/069167 (Sep. 26, 2019). In some embodiments, the build platform has an adhesive release sheet applied to the planar top surface thereof, on which the thermoforming molds are additively manufactured. In some embodiments, the release sheet is preferably comprised of a light-transmissive polymer material, as described in X. Gu, PCT Patent Application Pub. No. WO 2018/118832 (published 28 Jun. 2018). In such embodiments the exposed surface of the release sheet is considered as the top surface 52 of the platform.

In some embodiments, the additively manufactured objects include an external surface and an internal cavity, chamber, or well having an internal surface, wherein the residual resin is on both the external surface and the internal surface (for example, with residual resin partially or wholly filling the internal cavity), and the objects include at least one passage (e.g., at least one drain channel, or native opening in the object) between the external surface and the internal surface. Examples include, but are not limited to, electrical, mechanical, and fluid connectors, electrical/electronic housings, mechanical device housings, and the like.

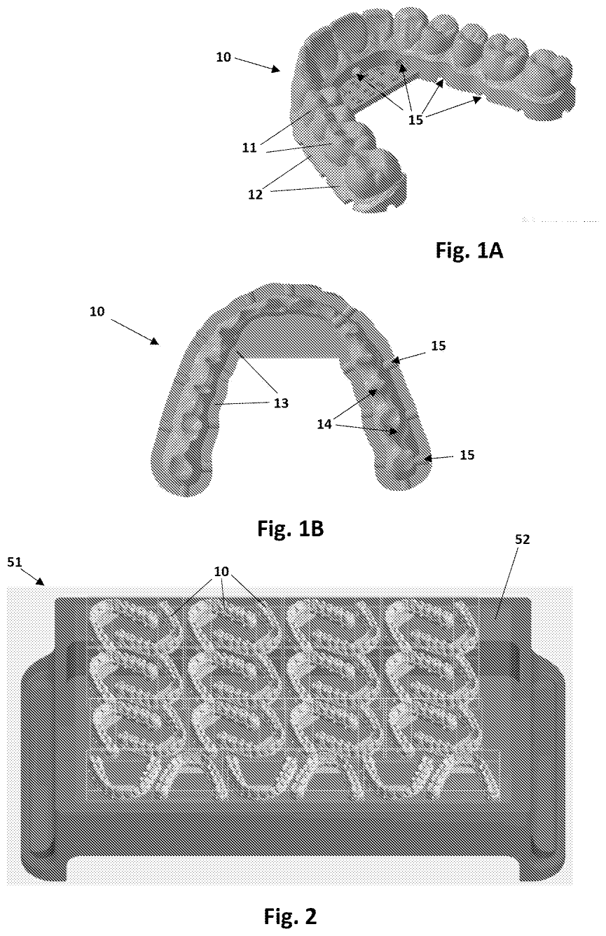

Particular examples of suitable objects are given in FIGS. 1A, 1B, and 2, showing molds or models in the shape of dental arches 10, typically used for thermoforming dental appliances (including but not limited to orthodontic aligners, orthodontic retainers, orthodontic splints, dental night guards, dental bleaching (or whitening) trays, and combinations thereof). Such molds typically include an outer surface portion comprising an upper portion configured in the shape of a set of teeth 11 and an intermediate portion 12; a planar base surface portion 13, and a hollow cavity 14 formed in said intermediate portion, the hollow cavity extending through said base surface portion and optionally (but in some embodiments preferably) extending into the upper portion. Preferably, for purposes of the methods described herein, the molds are further modified to include a plurality of drain channels 15 extending (in any orientation or configuration) from the hollow cavity through the surface portion, the drain channels configured for draining residual polymerizable resin from the hollow cavity during said centrifugally separating step. As shown in FIG. 2, the molds are, in some preferred embodiments, or oriented horizontally on the build surfaces 52, of the build platforms on which they are additively manufactured, with the mold base surface portion 13 adhered to the build surfaces. The number of drain channels will depend upon factors such as the size, shape, and position of the drain channels, the viscosity of the additive manufacturing resin, and the speed at which spinning for centrifugal separation is carried out. In general, there are preferably at least 10, 20, 30, or 40 drain channels, and preferably not more than 100, 200, or 300 drain channels.

3, Centrifugal Separator with Reversible Platform Rotor.

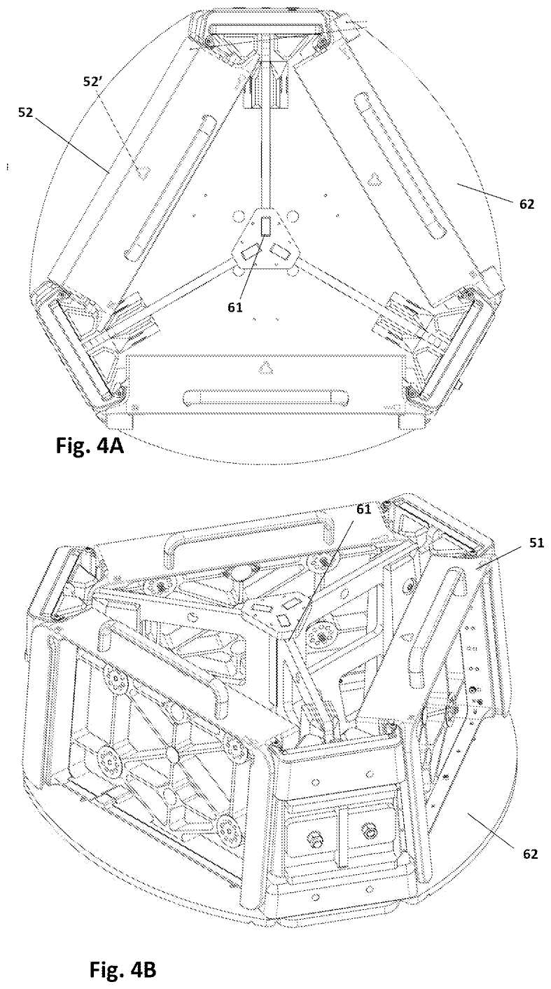

Components of an apparatus for carrying out the methods described herein can be as set forth in Murillo and Dachs, Resin extractor for additive manufacturing, US Patent App. Pub. No. 2021/0086450 (Mar. 25, 2021) (the disclosure of which is incorporated by reference herein in its entirety), or variations thereof that will be apparent to those skilled in the art, with the rotor further modified as described herein below. Such an apparatus typically includes an outer vessel, a rotor in the vessel, the rotor defining a center axis of rotation; a drive assembly operatively associated with the rotor; and a plurality (e.g., 2, 3, 4, 5, 6, etc.) of build platform mount assemblies operatively associated with the rotor, each mount assembly configured to receive a build platform in (i) a first orientation in which the build surfaces face toward the axis of rotation, and (ii) a second orientation in which the build surfaces face away from the axis of rotation. Referring to FIGS. 4A-4B, the rotor may be comprised of a center drive shaft 61 and a rotor platform comprised of one or more platform panels 62, with additional supporting structures (such as for joining the platform mount assemblies and platform panels to the rotor) included as appropriate for different designs thereof.

The mount assemblies are preferably configured to slidably receive each build platform in both the first orientation and the second orientation (making transfer of platforms in and out of the apparatus simpler).

In some embodiments, the rotor platform 62 is configured as a shield connected to the rotor beneath the build platform mount assemblies, the shield configured to reduce contact of residual resin to the back surface of the build platforms when the build platforms are received in the mount assemblies in the first orientation in which the build surfaces face toward the axis of rotation.

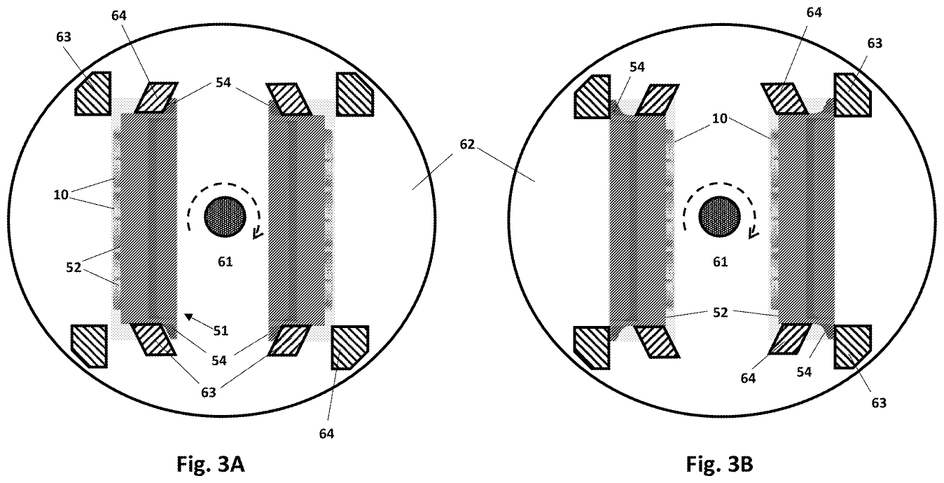

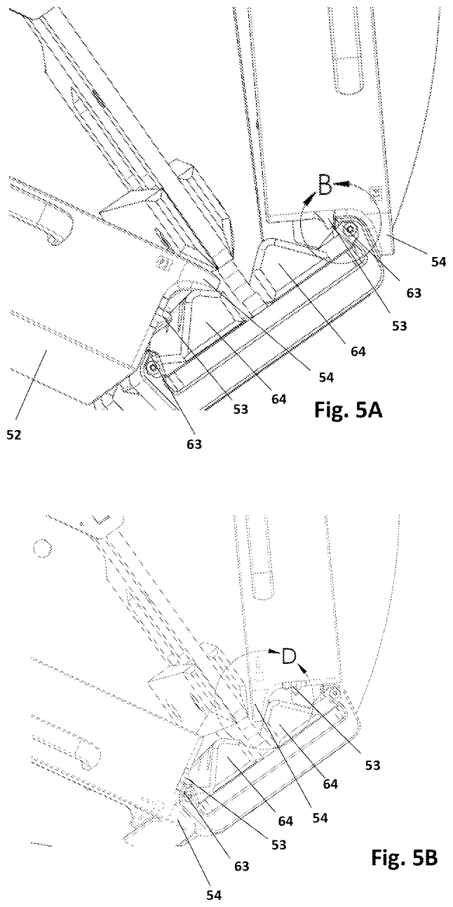

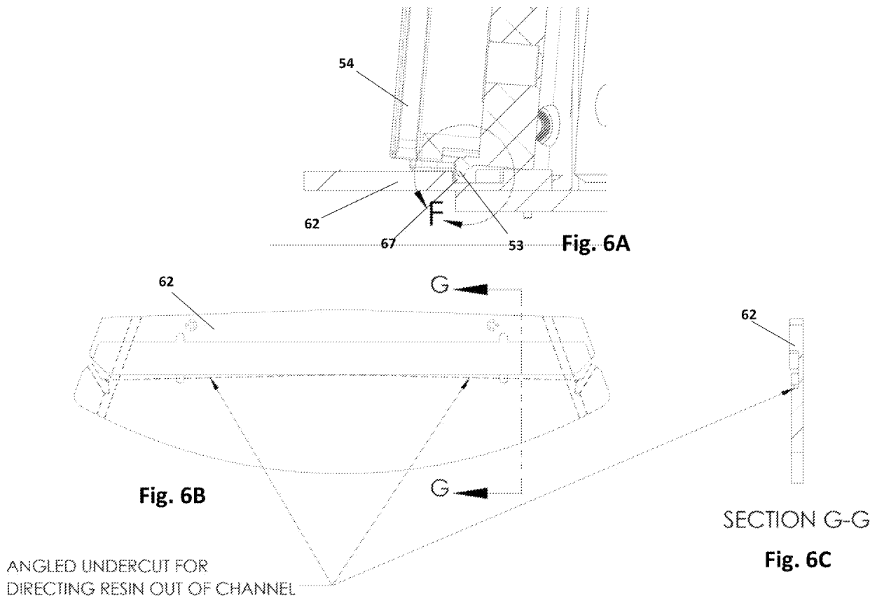

The mount assemblies can be configured in a variety of ways. In some embodiments, the mount assemblies include at least one pair of opposite facing bumpers or rails configured for abutting side edge portions of a build platform, or configured for engaging corresponding engagement features (e.g., slots, rails, etc.) on a build platform side edge portion. In the embodiment of FIGS. 3A-3B, each mount assembly comprises a pair of bumpers, one pair 64 of which engages a rail 54 on each side of the build platform to hold the build platform in an outward-facing direction, and another pair of bumpers 63 which engages the opposite surface of the same rail (or another portion of the side edge portion of the build platform) to hold the build platform in an inward-facing direction. Numerous additional configurations are, however, available: The bumpers can be replaced with a pair of slots or a single slot; the rails replaced with rollers or tabs; an additional rail 53 or slot can be included on the build platform if desired, as shown in the embodiment of FIGS. 4A-7C.

In preferred embodiments, and as shown in FIGS. 4A-4B, the mount assemblies are configured to receive each build platform with a top portion thereof leaning towards the axis of rotation (e.g., by an angle of 3, 4 or 5 degrees, up to 10 or 12 degrees). The slope of the platforms causes the centripetal acceleration when spinning to retain the platforms to the turntable, removing the need for any additional latching features (simplifying loading and unloading of the platforms to the turntable), or if latching features are included, reducing the load on the latches. The slope of the platform also aids in channeling and directing drainage of residual resin downward when the build surfaces face towards the axis of rotation.

In some embodiments, the mount assemblies include at least one resin flow feature (e.g., a gutter, drain, awning, channel, or the like) configured for channeling, collecting, and/or directing the flow of residual resin during centrifugal separation of residual resin from additively manufactured objects on the build surface. For example, the apparatus of FIGS. 4A-6C can include channel(s) 67 in the rotor platform, into which rail 53, which is also configured as an overhang or “awning” that directs residual resin flow along the sides, and bottom, of the panel, can nest.

### 4. Build Platforms.

While apparatus as described above can be configured to accommodate existing build platforms, in some cases the build platform is also modified to include features that facilitate it being reversible. In general, such a platform includes:
(a) a body having a (preferably generally rectangular) planar build surface 52, a top portion 51t, a bottom portion 51b, and two opposing side portions 51s;
(b) a first pair of opposite-facing engagement features (for example, rails 54) on the opposing side portions, the engagement features configured for engaging a build platform mount of a centrifugal separator in a first orientation in which the build surface faces toward the axis of rotation; and
(c) a second pair of opposite-facing engagement features (for example, rails 53) on the opposing side portions, the engagement features configured for engaging a build platform mount of a centrifugal separator in a second orientation in which the build surface faces away from the axis of rotation.

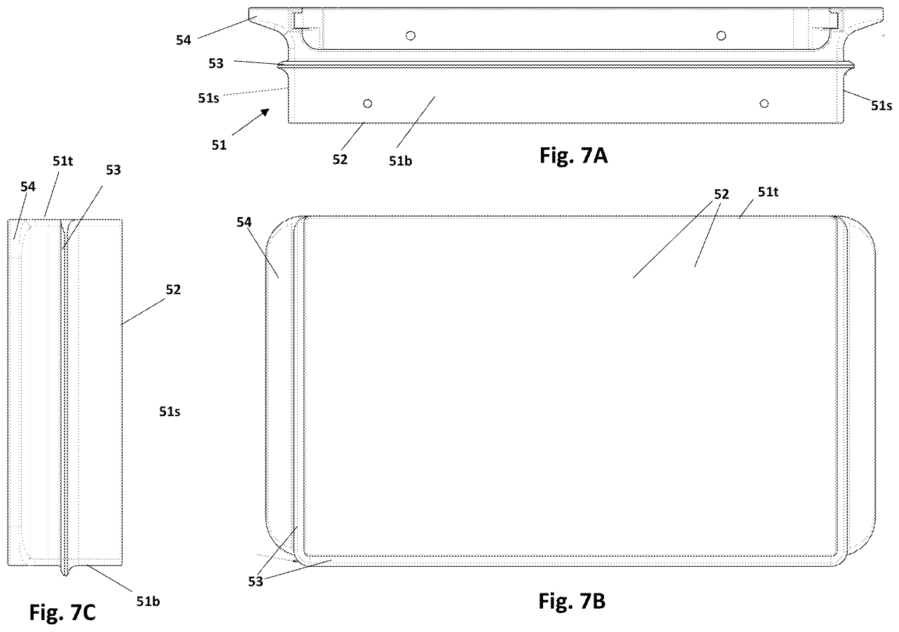

While rails 53, 54 are shown as the engagement features in FIGS. 7A-7C, it will be appreciated that alternate structures can be used, including but not limited to slots, tabs, rollers, and the like.

In preferred embodiments, the build platform includes a resin flow feature (e.g., a gutter, drain, awning, channel, or the like) on the opposing side portions, and optionally but preferably on the bottom portion, the flow feature configured for channeling, collecting, and/or directing the flow of residual resin during centrifugal separation of residual resin from additively manufactured objects on the build surface (particularly when the build surface is facing towards the axis of rotation. In the illustrated embodiment, rail 53 wraps continuously from the side to the bottom of the build platform, and the reverse side (the side not contacting bumpers) and edges of the rail are configured to facilitate resin flow and drainage.

Note, in FIG. 4B, the underside or back side 58 of the build platform can contain features (e.g., additional slots, draw-in pins, etc.) which are involved in securing the build platform to the additive manufacturing apparatus, can contain cut-outs or honeycombing to lighten the platform, and other features which if contaminated by back-spray of resin during centrifugal separation—particularly when the build platform is facing inward—can be laborious to clean, in spite of the inclusion of the resin flow features described herein. To reduce such contamination, a removable back-cover (e.g., a slide-in or snap in cover) can be included.

### 5. Resin Separation Methods

A method of separating residual resin from additively manufactured objects, the objects carried on a build surface 52 of a build platform 51 on which the objects were additively manufactured, includes the steps of:
mounting a plurality of build platforms to a rotor of a centrifugal separator in either (i) an orientation in which all of the build surfaces face toward said axis of rotation, or (ii) an orientation in which all of the build surfaces face away from said axis of rotation; then
centrifugally separating residual resin from the additively manufactured objects by spinning the rotor; then
removing each of the plurality of build platforms from the rotor and then
re-mounting each of the plurality of build platforms to said rotor in the other of (i) the orientation in which all of the build surfaces face toward the axis of rotation, or (ii) the orientation in which all of the build surfaces face away from the axis of rotation; and then
centrifugally separating additional residual resin from the additively manufactured objects by spinning the rotor.

In some preferred embodiments, the mounting step is carried out with said build platforms/build surfaces facing toward the axis of rotation, and the re-mounting step is carried out with said build platforms/build surfaces facing away from the axis of rotation. This reduces the possibility of residual resin inside of parts re-contaminating outer surfaces of objects if the objects were first spun with the build surfaces facing out.

In some embodiments, all of the build platforms have the same configuration, and same center of mass. In this, the mounting and re-mounting steps are preferably carried out with the center of mass located the same distance (plus or minus 5 or 10 percent) from the axis of rotation, for all of the platforms. This feature can be achieved by configuring mounting assemblies on the rotor and/or mounting features on the build platform to achieve the desired effect. This feature serves to ensure the rotor encounters the same resonant frequency during acceleration of spin in each centrifugal separation step, and also provides a safety feature in the event one of the platforms is inadvertently mounted in the wrong orientation during one of the centrifugal separation steps. If desired, cooperating sensors can be included on the build platforms and on the rotor, and operatively associated with the apparatus controller, to sense the positions of the build platforms when mounted on the rotor, and lock out the rotor from starting if one or more build platform is positioned in the rotor in an incorrect orientation.

Preferably, the method is carried out in a vessel or chamber to contain the residual resin, and either one, or both, of the centrifugally separating steps further include channeling or directing separated residual resin towards a limited location within the vessel (for example, where the vessel has an interior wall with an upper and lower portion, channeling or directing separated residual resin toward the lower portion). This may be accomplished with including at least one, or a plurality of, resin flow features (such as described above) operatively associated with each of the mount assemblies, each build platform, or a combination thereof (i.e., cooperating flow-directing features formed on, connected to, or operatively associated with both the mount assemblies and the build platforms).

Additional steps. Additional steps after centrifugal cleaning depend upon the particular objects being cleaned. For dental molds for thermoforming, the process continues in accordance with known techniques by further curing, concurrently or sequentially, the external surface portion and the bottom portion of each the plurality of molds with actinic radiation or light (e.g., ultraviolet light); then thermoforming a thermoplastic polymer sheet (such as a clear thermoplastic polymer sheet) on each mold external surface portion to produce the plurality of polymer dental appliances; and then separating the plurality of polymer dental appliances from each the mold. Additional steps such as further cleaning and trimming the appliances can be included in accordance with known techniques.

The foregoing is illustrative of the present invention, and is not to be construed as limiting thereof. The invention is defined by the following claims, with equivalents of the claims to be included therein.

We claim:

1. A centrifugal separator for separating residual resin from additively manufactured objects, the objects carried on a build surface of a build platform on which the objects were additively manufactured, the separator comprising:
an outer vessel;
a rotor in said vessel, said rotor defining a center axis of rotation;
a drive assembly operatively associated with said rotor; and
a plurality of build platform mount assemblies operatively associated with said rotor, each mount assembly configured to receive each said build platform in (i) a first orientation in which said build surfaces face toward said axis of rotation, and (ii) a second orientation in which said build surfaces face away from said axis of rotation.

2. The separator of claim 1, each said mount assembly configured to slidably receive each said build platform in both said first orientation and said second orientation.

3. The separator of claim 1, further comprising a shield connected to said rotor beneath said build platform mount assemblies, said shield configured to reduce contact of residual resin to the back surface of the build platforms when the build platforms are received in said mount assemblies in said first orientation in which said build surfaces face toward said axis of rotation.

4. The separator of claim 1, said mount assemblies configured to receive each said build platform with a top portion thereof leaning toward said axis of rotation.

5. The separator of claim 1, said mount assemblies including at least one resin flow feature configured for channeling, collecting, and/or directing the flow of residual resin during centrifugal separation of residual resin from additively manufactured objects on said build surface.

6. The separator of claim 1, wherein said mount assemblies include at least one pair of opposite facing bumpers or rails configured for abutting side edge portions of a build platform, or configured for engaging corresponding engagement features on a build platform side edge portion.

7. A method of separating residual resin from additively manufactured objects, the objects carried on a build surface of a build platform on which the objects were additively manufactured, the method comprising:
mounting a plurality of build platforms to a rotor of a centrifugal separator in either (i) an orientation in which all of said build surfaces face toward an axis of rotation of said rotor, or (ii) an orientation in which all of said build surfaces face away from said axis of rotation; then
centrifugally separating residual resin from said additively manufactured objects by spinning said rotor; then
removing each of said plurality of build platforms from said rotor and;
re-mounting each of said plurality of build platforms to said rotor in the other of (i) said orientation in which all of said build surfaces face toward said axis of rotation, or (ii) said orientation in which all of said build surfaces face away from said axis of rotation; and then
centrifugally separating additional residual resin from said additively manufactured objects by spinning said rotor.

8. The method of claim 7, wherein said objects include an external surface and an internal cavity, chamber, or well having an internal surface, wherein said residual resin is on both said external surface and said internal surface, and said objects include at least one passage between said external surface and said internal surface.

9. The method of claim 7, wherein said mounting step is carried out with said build platforms facing toward said axis of rotation, and said re-mounting step is carried out with said build platforms facing away from said axis of rotation.

10. The method of claim 7, wherein all of said build platforms have the same configuration, each has a center of mass, and both said mounting and re-mounting steps are carried out with said center of mass located the same distance (plus or minus 5 or 10 percent) from the axis of rotation.

11. The method of claim 7, each said object comprising a mold in the shape of a dental arch produced by additive manufacturing from a polymerizable resin, said mold comprising:
an outer surface portion comprising an upper portion configured in the shape of a set of teeth and an intermediate portion;
a planar base surface portion,
a hollow cavity formed in said intermediate portion, said hollow cavity extending through said base surface portion and optionally extending into said upper portion; and
a plurality of drain channels extending from said hollow cavity through said surface portion, said drain channels configured for draining residual polymerizable resin from said hollow cavity during said centrifugally separating step.

12. The method of claim 11, wherein each said mold is oriented horizontally on said build surfaces, with said mold bottom surface portion adhered to said build surfaces.

13. The method of claim 7, wherein said centrifugally separating steps are carried out in a vessel, and either one, or both, of said centrifugally separating steps further include channeling or directing separated residual resin toward a limited location within said vessel.

14. The method of claim 13, wherein said channeling or directing are carried out with at least one, or a plurality of, resin flow features operatively associated with each said mount assemblies, each said build platform, or a combination thereof.

15. A build platform on which objects can be produced by additive manufacturing and then cleaned of residual resin in a centrifugal separator, the centrifugal separator having an axis of rotation, the build platform comprising:
(a) a body having a planar build surface, a top portion, a bottom portion, and two opposing side portions;
(b) a first pair of opposite-facing engagement features on said opposing side portions, said engagement features configured for engaging a build platform mount of a centrifugal separator in a first orientation in which said build surface faces toward the axis of rotation; and
(c) a second pair of opposite-facing engagement features on said opposing side portions, said engagement features configured for engaging a build platform mount of a centrifugal separator in a second orientation in which said build surface faces away from the axis of rotation.

16. The build platform of claim 15, wherein:
said first pair of opposite-facing engagement features comprises a slot or rail extending along each said opposing side portion; and/or
said second pair of opposite-facing engagement features comprises a slot or rail extending along each said opposing side portion.

17. The build platform of claim 15, further comprising a resin flow feature on said opposing side portions, and optionally but preferably on said bottom portion, said flow feature configured for channeling, collecting, and/or directing the flow of residual resin during centrifugal separation of residual resin from additively manufactured objects on said build surface.
